(19) United States
(12) Patent Application Publication
(10) Pub. No.: US 2008/0106210 A1
(43) Pub. Date: May 8, 2008

(54) Plasma display apparatus and driving device and switching element therefor

(76) Inventors: Chan-Young Han, Suwon-si (KR); Hyun-Jun Do, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/822,348

(22) Filed: Jul. 5, 2007

(30) Foreign Application Priority Data
Nov. 7, 2006 (KR) 10-2006-0109470

(51) Int. Cl. H01J 17/49; G09G 3/10

(52) U.S. Cl. 315/169.4; 313/584

(57) ABSTRACT

A plasma display device may include a driving circuit and a switching element. The driving circuit unit includes a first switching element that has a first terminal connected to a first power source supplying a voltage and a second terminal connected to the first electrodes. The first switching element includes at least one insulated gate bipolar transistor and at least one metal-oxide semiconductor field-effect transistor that are connected in parallel, and are controlled by different voltages.

### BACKGROUND OF THE INVENTION

1. Field of the Invention

The present invention relates to a plasma display apparatus. More particularly, the present invention relates to a driving device and a switching element for the plasma display apparatus.

2. Description of the Related Art

Plasma displays are apparatuses that may display texts or images using plasma generated by gas discharge. A plasma display panel of a plasma display apparatus may include tens of thousands to millions or more discharge cells, which may be arranged in a matrix, according to the size of panel.

Generally, in a plasma display apparatus, one frame may be divided into multiple subfields to be driven. A grayscale display may be realized by combining weight values of subfields performing a display operation among the multiple subfields. The driving period of each subfield may be divided into a reset period, an address period, and a sustain period. Wall charge states of discharge cells may be initialized during the reset period. Cells to be turned on and cells not to be turned on may be selected during the address period. During the sustain period, sustained discharge of the cells to be turned on may be performed to display an image. The reset period, the address period, and the sustain period may be performed using an on/off operation of multiple switching elements included in a driving device for the plasma display apparatus.

Generally, driving devices for a plasma display apparatus may mainly use two kinds of switching elements: metal-oxide semiconductor field-effect transistors (MOSFETs) and insulated gate bipolar transistors (IGBTs). Multiple MOSFETs or multiple IGBTs may be connected in parallel in order to cope with an increase in current capacity and a dramatic increase in resistance value between the drain and source of each MOSFET or IGBT corresponding to an increase in an applied voltage when the MOSFET or IGBT is turned on.

However, MOSFETs and IGBTs may have different merits and drawbacks, and may thus exhibit different driving characteristics. For this reason, when only one of the types of switching elements are connected in parallel, as in the related art, it may be difficult to overcome the drawbacks of exclusively using either MOSFETs or IGBTs.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention is therefore directed to a plasma display device including a switching element, which substantially overcomes one or more of the problems due to the limitations and disadvantages of the related art.

It is therefore a feature of an embodiment of the present invention to provide a plasma display apparatus realizing a high-efficiency driving device without decreasing luminance, and a driving device and switching element therefore.

It is therefore a feature of an embodiment of the present invention to provide a plasma display apparatus realizing a high-efficiency driving device without increasing power, and a driving device and switching element therefore.

At least one of the above and other features and advantages of the present invention may be realized by providing a plasma display apparatus which may include a plasma display panel that includes multiple first electrodes, multiple second electrodes, and multiple third electrodes formed to intersect the first and second electrodes, first to third driving circuit units which drive the first to third electrodes, and a controller which generates a control signal for controlling the driving of the first to third driving circuit units. The first driving circuit unit may include a first switching element which has a first terminal connected to a first power source supplying a first voltage and a second terminal connected to the first electrodes. The first switching element may include at least one insulated gate bipolar transistor and at least one metal-oxide semiconductor field-effect transistor which are connected in parallel. A control electrode of the first switching element may be connected to the first power source supplying the first voltage, the insulated gate bipolar transistor may be turned on or off by a second voltage corresponding to the first voltage, and the metal-oxide semiconductor field-effect transistor may be turned on or off by a third voltage, which corresponds to the first voltage, but is different from the first voltage.

The first driving circuit unit may further include a second switching element having a first terminal connected to a second power source supplying a fourth voltage, the second switching element having a second terminal connected to the second electrodes. The second switching element may include at least one insulated gate bipolar transistor and at least one metal-oxide semiconductor field-effect transistor which are connected in parallel, and a control electrode of the second switching element may be connected to the second power source supplying the fourth voltage. The insulated gate bipolar transistor may be turned on or off by a fifth voltage corresponding to the fourth voltage, and the metal-oxide semiconductor field-effect transistor is turned on or off by the sixth voltage, which corresponds to the fourth voltage, but is different from the fifth voltage.

The third driving circuit unit may include a third switching element having a first terminal connected to a third power source supplying a seventh voltage and a second terminal connected to the third electrodes. The third switching element may include at least one insulated gate bipolar transistor and at least one metal-oxide semiconductor field-effect transistor connected in parallel, and control electrodes of the first and second switching elements connected to the third power source supplying the seventh voltage. The insulated gate bipolar transistor may be turned on or off by an eighth voltage corresponding to the seventh voltage, and the metal-oxide semiconductor field-effect transistor may be turned on or off by a ninth voltage, which corresponds to the seventh voltage, but is different from the eighth voltage. The first and fourth voltages may be alternately applied during a sustain period. The fifth voltage may be a voltage to which the fourth voltage drops by a first resistor connected to a control electrode of the insulated gate bipolar transistor, and the sixth voltage may be a voltage to which the fourth voltage drops by a second resistor connected to a control electrode of the metal-oxide semiconductor field-effect transistor. The first resistor may have a resistance larger than the second resistor.

At least one of the above and other features and advantages of the present invention may be realized by providing a driving device for a plasma display apparatus which includes multiple first electrodes, multiple second electrodes, and multiple third electrodes formed to intersect the first and second electrodes. The driving device may include a first switching element which has a first terminal connected to a first power source supplying a first voltage and a second terminal connected to the first electrodes. The first switching element may include at least one insulated gate bipolar transistor and at least one metal-oxide semiconductor field-effect transistor which are connected in parallel. A control electrode of the first switching element may be connected to the first power source, and the insulated gate bipolar transistor may be turned on or off by a second voltage corresponding to the first voltage, and the metal-oxide semiconductor field-effect transistor may be turned on or off by a third voltage, which corresponds to the first voltage, but is different from the second voltage.

At least one of the above and other features and advantages of the present invention may be realized by providing a switching element for a plasma display apparatus which includes multiple first electrodes, multiple second electrodes, and multiple the third electrodes formed to intersect the first and second electrodes. The switching element may include at least one insulated gate bipolar transistor which may be turned on or off by a second voltage corresponding to a first voltage, and at least one metal-oxide semiconductor field-effect transistor connected in parallel with the insulated gate bipolar transistor and may be turned on or off by a third voltage, which corresponds to the first voltage, but is different from the second voltage.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a block diagram of a plasma display apparatus according to an exemplary embodiment of the present invention;

FIG. 2 illustrates a driving waveform of the plasma display apparatus according to an exemplary embodiment of the present invention;

FIG. 3 illustrates a schematic diagram of a switching element according to an exemplary embodiment of the present invention;

FIG. 4 illustrates plots of driving characteristics of an IGBT Q1 and a MOSFET Q2 related to temperature;

FIG. 5A and FIG. 5B illustrate the relationship between a voltage Vce of the IGBT Q1 and a current Ic of the IGBT Q1 at temperatures of 25° C. and 125° C., respectively;

FIG. 6A illustrates the relationship between the voltage Vce and the current Ic of a switching element composed of only the IGBT Q1;

FIG. 6B illustrates the relationship between the voltage Vce and the current Ic of a switching element according to an exemplary embodiment of the present invention;

FIG. 7 illustrates a schematic diagram of a driving device for a plasma display apparatus using a switching element according to an exemplary embodiment of the present invention; and

FIG. 8 illustrates a table representing a variation in the temperature of each of switching elements S1 and S3 corresponding to a variation in the resistance values of resistors R1 and R2 included in the switching element S1, and luminance and power consumption of a plasma display apparatus corresponding to the variation in the resistance values, according to an exemplary embodiment of the present invention.

### DETAILED DESCRIPTION OF THE INVENTION

Korean Patent Application No. 10-2006-0109470, filed on Nov. 7, 2006, in the Korean Intellectual Property Office, and entitled: “Plasma Display Apparatus and Driving Device and Switching Element Therefore,” is incorporated by reference herein in its entirety.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element.

Also, throughout this specification, the term “wall charges” means charges generated close to each electrode on a wall of a cell (for example, a dielectric layer). Although the wall charges do not actually touch the electrodes, in this specification, the wall charges are expressed as “formed” “accumulated” “piled up” on each electrode, and a wall voltage means a potential difference formed in a wall of a cell by wall charges.

A plasma display apparatus, and a driving device and a switching element according to embodiments of the present invention will be described in detail with reference to the accompanying drawings.

The present invention provides a plasma display apparatus realizing a high-efficiency driving device without decreasing luminance or increasing power consumption, and a driving device and a switching element therefore.

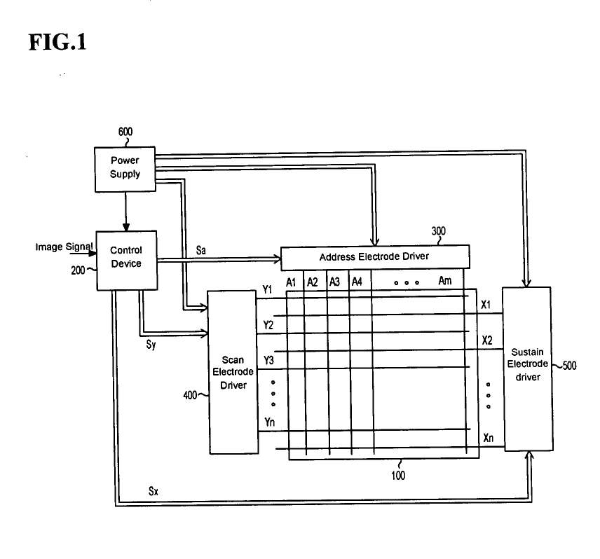

FIG. 1 illustrates a block diagram of a plasma display apparatus according an exemplary embodiment of the present invention.

As shown in FIG. 1, a plasma display apparatus may include a plasma display panel 100, a control device 200, an address electrode driver 300, a scan electrode driver 400, a sustain electrode driver 500, and a power supply 600.

The plasma display panel 100 may include multiple address electrodes A1, A2 . . . Am extending in a column direction, and multiple sustain electrodes X1, X2 . . . Xn and multiple scan electrodes Y1, Y2 . . . Yn extending in a row direction while forming pairs. The sustain electrodes X1, X2 . . . Xn may be formed to correspond to the scan electrodes Y1, Y2 . . . Yn. Ends of the sustain electrodes X1, X2 . . . Xn on one side may be connected to a common terminal. The plasma display panel 100 may include a substrate (not shown) having the sustain electrodes X1, X2 . . . Xn and the scan electrodes Y1, Y2 . . . Yn arranged thereon, and a substrate (not shown) having the address electrodes A1, A2 . . . Am arranged thereon. The two substrates may be facing each other with a discharge space interposed therebetween such that the scan electrodes Y1, Y2 . . . Yn and the sustain electrodes X1, X2 . . . Xn are orthogonal to the address electrodes A1, A2 . . . Am. In this case, the discharge spaces positioned at the intersections between the address electrodes A1, A2 . . . Am and the sustain and scan electrodes X1, X2 . . . Xn and Y1, Y2 . . . Yn may form multiple discharge cells. The structure of the plasma display panel 100 is just an illustrative example, and panels having different structures to which a driving waveform, which will be described below, may be applied.

When receiving an external video signal, the control device 200 may output an address electrode driving control signal Sa, a sustain electrode driving control signal Sx, and a scan electrode driving control signal Sy. The control device 200 may drive one frame which is divided into multiple subfields, and each subfield may be composed of a reset period, an address period, and a sustain period according to temporal variations in operation. Also, the control device 200 may generate a scan high voltage Vscan_h to be applied to a cell, which is not addressed in the address period, using a DC voltage supplied from the power supply 600, and the control device 200 may transmit the generated scan high voltage to the scan electrode driver 400 or the sustain electrode driver 500.

The address electrode driver 300 may receive the address electrode driving control signal Sa from the control device 200, and the address electrode driver 300 then may apply a display data signal to each address electrode to select discharge cells to be displayed.

The scan electrode driver 400 may receive the scan electrode driving control signal Sy from the control device 200, and the scan electrode driver 400 then may apply a driving voltage to each scan electrode Y.

The sustain electrode driver 500 may receive the sustain electrode driving control signal Sx from the control device 200, and the sustain electrode driver 500 then may apply a driving voltage to each sustain electrode X.

The power supply 600 may supply power necessary to drive the plasma display apparatus to the control device 200, and to the individual drivers 300, 400, and 500.

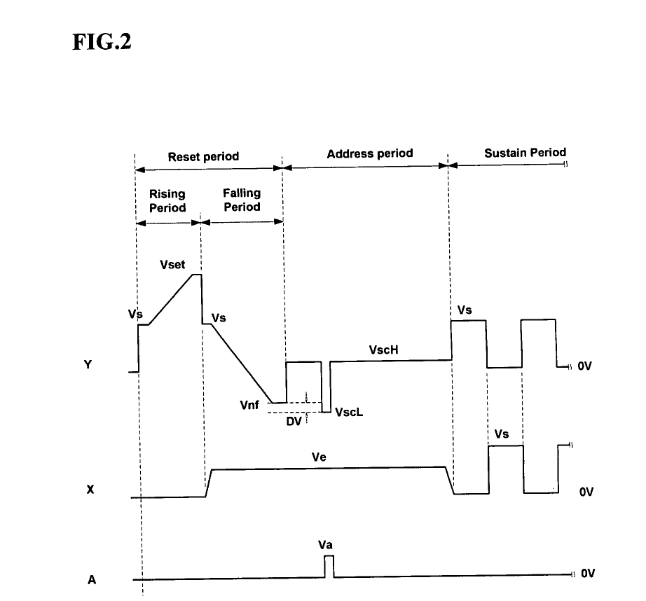

FIG. 2 illustrates a driving waveform of the plasma display apparatus according to an exemplary embodiment of the present invention.

In FIG. 2, the driving waveform of the plasma display apparatus corresponding to only one subfield, i.e., one subfield of the plasma display panel (reference numeral 100 in FIG. 1), may be composed of a reset period, an address period, and a sustain period corresponding to the variation in the input voltages of the sustain electrode X, the scan electrode Y and the address electrode A according to the control device (reference numeral 200 in FIG. 1).

First, the reset period will be described. The reset period may include a rising period and a falling period. During the rising period, in a state in which the voltages of the address electrode A and the sustain electrode X are maintained at a reference voltage (about 0 V in FIG. 2), the voltage of the scan electrode Y may gradually increase from a voltage Vs to a voltage Vset. The increase in the voltage of the scan electrode Y may cause a weak discharge between the scan electrode Y and the sustain electrode X, and the increase in the voltage of the scan electrode Y may also cause a weak discharge between the scan electrode Y and the address electrode A. Negative wall charges may thus be formed on the scan electrode Y, and positive wall charges may thus be formed on the sustain electrode X and the address electrode A. The sum of an externally applied voltage and a wall voltage between the individual electrodes due to the wall charges formed when the voltage of the scan electrode Y reaches Vset may be equal to a discharge firing voltage Vf. In the reset period, statuses of all cells should be initialized, which may cause the voltage Vset to be set to a voltage at which cells may be discharged in every condition. In FIG. 2, a case in which the voltage of the scan electrode Y increases or decreases in a ramp pattern is shown. However, a waveform in which the voltage of the scan electrode Y gradually increases or decreases may also be applied.

During the falling period, in a state in which the voltages of the address electrode A and the sustain electrode X are maintained at the reference voltage and a voltage Ve, respectively, the voltage of the scan electrode Y may gradually decrease from the voltage Vs to a voltage Vnf. The decrease in the voltage of the scan electrode Y may cause a weak discharge between the scan electrode Y and the sustain electrode X, and between the scan electrode Y and the address electrode A, so as to eliminate the negative charges formed on the scan electrode Y during the rising period and the positive wall charges formed on the sustain electrode X and the address electrode A during the rising period. As a result, the amount of negative charges on the scan electrode Y and the amount of positive wall charges on the sustain electrode X and the address electrode A may be reduced. At this time, the amount of positive wall charges on the address electrode A may be reduced to a desired amount necessary for an address operation. The difference between the voltage Vnf and the voltage Ve may be set to be approximate to the discharge firing voltage Vf between the scan electrode Y and the sustain electrode X, such that the wall voltage difference between the scan electrode Y and the sustain electrode X may approach about 0V, which may prevent discharge of the cells in which address discharge has not occurred during the address period from being discharged during the sustain period.

One falling period of the above-mentioned reset period may essentially exist in each subfield. In contrast, existence or non-existence of the rising period in each subfield may be determined according to a control program preset in the control device (reference numeral 200 in FIG. 1).

During the address period, in order to select cells to emit light, while the voltage Ve is applied to the sustain electrodes X, a scan pulse having a voltage VscL (scan voltage) may be sequentially applied to the multiple scan electrodes Y. Simultaneously, an address voltage Va may be applied to the address electrodes A that pass through cells to emit light among multiple cells driven by the scan electrodes Y to which the voltage VscL has been applied. Then, address discharge may occur between the address electrodes A, to which the address voltage Va is applied, and the scan electrodes Y, to which the voltage VscL is applied, and between the scan electrodes Y, to which the voltage VscL is applied, and the sustain electrodes X corresponding to the scan electrodes Y. As a result, positive wall charges may be formed on the scan electrodes Y, and negative wall charges may be formed on the address electrodes A and the sustain electrodes X. At this time, the voltage VscL may be set to a predetermined level lower than the voltage Vnf. Meanwhile, a voltage VscH (non-scan voltage), which may be higher than the voltage VscL, may be applied to the scan electrodes Y to which the voltage VscL is not applied, and the reference voltage may be applied to the address electrodes A of discharge cells that are not selected.

In the sustain period, sustain discharge pulses which alternately have a high-level voltage (the voltage Vs in FIG. 2) and a low-level voltage (about 0 V in FIG. 2), and whose phases are inverted, may be applied to the scan electrodes Y and the sustain electrodes X, respectively. As a result, when the voltage Vs is applied to the scan electrodes Y, a voltage of about 0 V may be applied to the sustain electrodes X. When the voltage Vs is applied to the sustain electrodes X, a voltage of about 0 V may be applied to the scan electrodes Y. Also, discharge may occur between the scan electrodes Y and the sustain electrodes X, due to the voltage Vs and the wall voltage formed between the scan electrodes Y and the sustain electrodes Y by the address discharge. Then, the process of applying the sustain discharge pulses to the scan electrodes Y and the sustain electrodes X may be repeated a number of times so as to correspond to a weight value represented by a corresponding subfield.

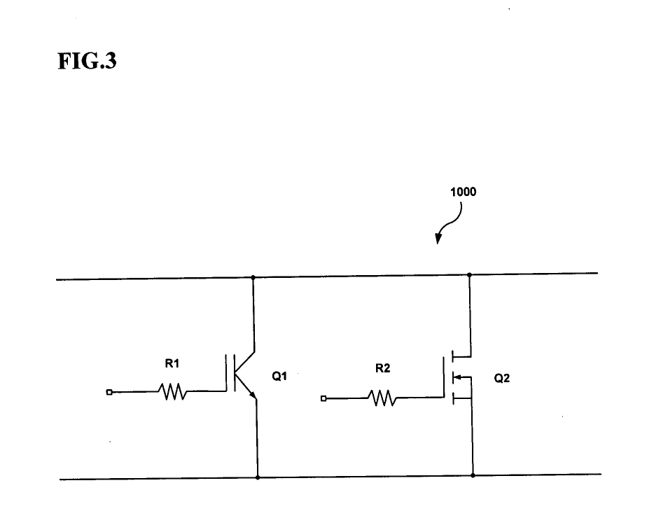

A switching element 1000, which may be widely used for the control device 200, the address electrode driver 300, the scan electrode driver 400, the sustain electrode driver 500, and the power supply 600, illustrated in FIG. 1, to obtain the driving waveform in FIG. 2, will be described with reference to FIG. 3.

FIG. 3 illustrates a schematic diagram of a switching element according to an exemplary embodiment of the present invention.

As shown in FIG. 3, the switching element 1000 may include an IGBT Q1 and a MOSFET Q2, which may be connected to each other in parallel. A control electrode of each of the IGBT Q1 and the MOSFET Q2 may be driven by a control signal supplied from the control device (reference numeral 200 in FIG. 1). The control signals supplied from the control device (reference numeral 200 in FIG. 1) to the control electrodes of the IGBT Q1 and the MOSFET Q2 may have the same voltage level. However, when the resistances of resistors R1 and R2 connected to the control electrodes of the IGBT Q1 and the MOSFET Q2 are different from each other, the control signals input to the control electrodes of the IGBT Q1 and the MOSFET Q2 may have different voltage levels.

In particular, the resistor R1 connected to the control electrode of the IGBT Q1 may have a larger resistance than the resistor R2 connected to the control electrode of the MOSFET Q2. When the switching element 1000 starts to be driven, the IGBT Q1 may be turned on later than the MOSFET Q2. Therefore, it may be possible to prevent a significant voltage drop when a small amount of current (hereinafter, referred to as a current Ic) flows from a collector to an emitter of the IGBT Q1 at the time when the IGBT Q1 is turned on. Also, since the switching element 1000 may be configured by connecting the IGBT Q1 and the MOSFET Q2 to each other in parallel, the efficiency thereof may be high not only when the switching element 1000 is turned on, but also when a pulse discharge current generated when the plasma display apparatus is discharged flows through the switching element 1000. The switching element 1000 shown in FIG. 3 illustrates one IGBT Q1 and one MOSFET Q2 connected to each other in parallel. However, alternative switching elements may be configured, e.g., by connecting multiple IGBTs Q1 and multiple MOSFETs Q2 in parallel.

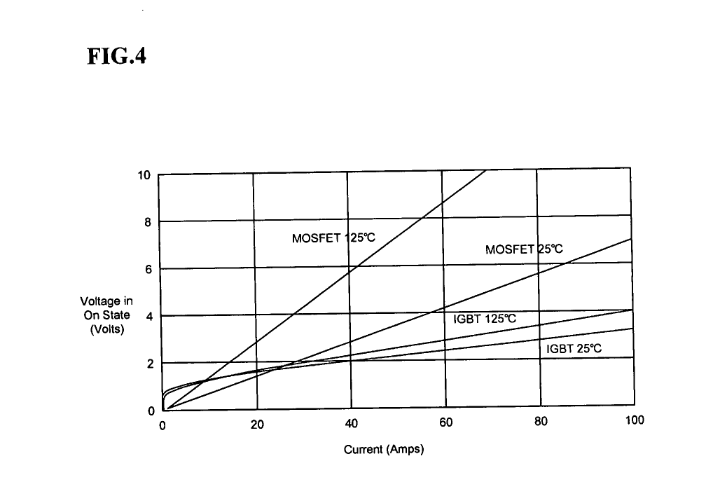

The driving characteristics of the above-mentioned switching element 1000 will be described with reference to FIGS. 4 to 6.

First, the driving characteristics of the IGBT Q1 and the MOSFET Q2 will be described below.

The IGBT Q1 may be a bipolar transistor element. When the IGBT Q1 is turned on, a voltage applied between the collector and the emitter (hereinafter, referred to as a voltage Vce) may be only a voltage applied to a diode, e.g., about 0.7 V, and when the amount of current flowing through the IGBT Q1 increases, the voltage may only increase slightly. The IGBT Q1 may have a higher current carrying capability per unit area than the MOSFET Q2 due to the structural characteristics of the IGBT Q1. Therefore, in a driving device requiring the same current capacity, the IGBT Q1 may occupy an area considerably smaller than the MOSFET Q2, which may make it possible to reduce the cost of the driving device.

However, the IGBT Q1 may have a turn-off characteristic that is worse than the MOSFET Q2. Generally, when the plasma display apparatus is driven, discharge may start due to the turn-on operation of the switching element 1000, and then the IGBT Q1 may allow a current to flow in a very large and short pulse form. Then, after the amount of current reaches about zero amperes, the switching element may be turned off. Therefore, the unfavorable turn-off characteristic of the IGBT Q1 may not matter when the plasma display apparatus is driven.

Meanwhile, the MOSFET Q2 may have a switching speed higher than the IGBT Q1. However, as the voltage resistance of the MOSFET Q2 increases, the resistance between the drain and source of the MOSFET Q2 may rapidly increase when the MOSFET Q2 is turned on. Particularly, during the address period and the sustain period shown in FIG. 2, a discharge current may flow in short and sharp pulses through the switching element 1000. In this case, as the voltage applied to the MOSFET Q2 increases, the resistance between the drain and source of the MOSFET Q2 may increase considerably. That is, the root mean square (RMS) current value of the MOSFET Q2 may be very large. For this reason, when the MOSFET Q2 is used, a current loss may be greater and the amount of heat generated may be larger as compared to the IGBT Q1.

The driving characteristics of the IGBT Q1 and the MOSFET Q2 may be more clearly seen by comparing current and voltage characteristics corresponding to variation in temperature. Hereinafter, the driving characteristics of the IGBT Q1 and the MOSFET Q2 according to the variation in temperature will be described with reference to FIG. 4.

FIG. 4 illustrates plots of the driving characteristics of the IGBT Q1 and the MOSFET Q2 according to temperature.

As shown in FIG. 4, even though the amount of current flowing though the IGBT Q1 becomes larger, the voltage of the IGBT Q1 may be very low (never greater than about 4 volts), i.e., the current loss may be small, as compared to the MOSFET Q2. Meanwhile, when the temperature rises from about 25° C. to about 125°, the voltage may exceed about 10 volts, and the current loss in the MOSFET Q2 may increase considerably. As the temperature rises, the current loss in the IGBT Q1 may also increase, but the increase in the current loss may be smaller than that in the MOSFET Q2. Therefore, the IGBT Q1 may exhibit better driving characteristics than the MOSFET Q2.

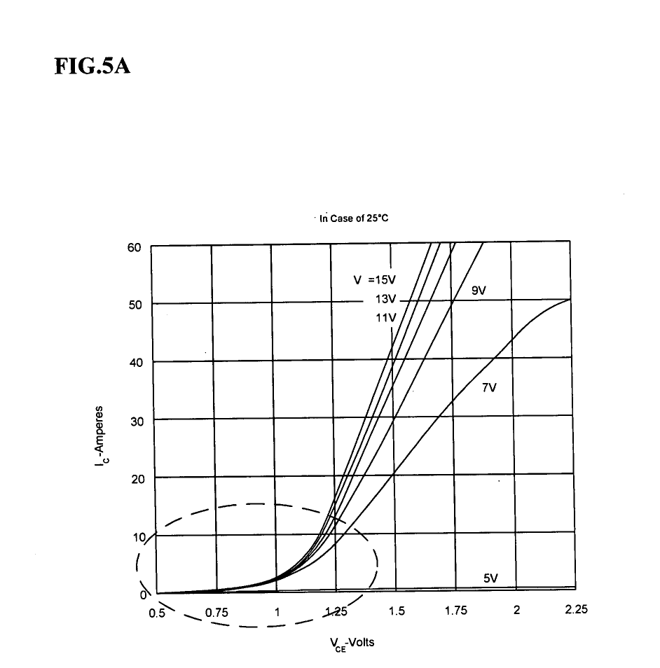

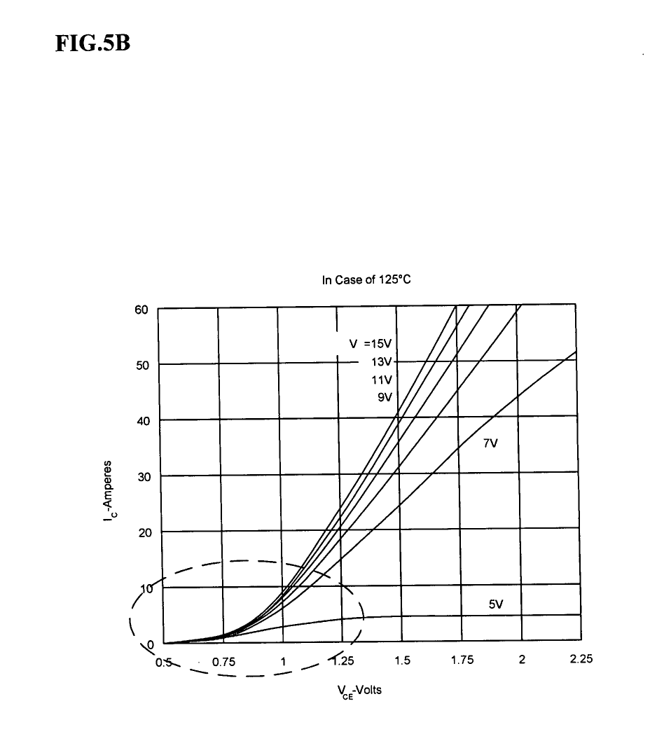

When the IGBT Q1 is turned on, the voltage Vce of the IGBT Q1 may have a positive temperature coefficient characteristic proportional to the temperature, which may cause a problem in that a load current is concentrated on one side. This will be described with reference to FIGS. 5A and 5B, which illustrate the relationship between the voltage Vc of the IGBT Q1 and the current Ic of the IGBT Q1 according to temperature.

FIG. 5A and FIG. 5B illustrate the relationship between the voltage Vc of the IGBT Q1 and the current Ic of the IGBT Q1 corresponding to 25° C. and 125°, respectively.

As shown in FIGS. 5A and 5B, the amount of current Ic of the IGBT Q1 may increase as the temperature rises. If the current Ic of the IGBT Q1 increases to exceed a predetermined level such that heat is generated, the temperature of the IGBT Q1 may rise so as to further increase the amount of current Ic of the IGBT Q1, which may cause a problem in that the load current becomes concentrated.

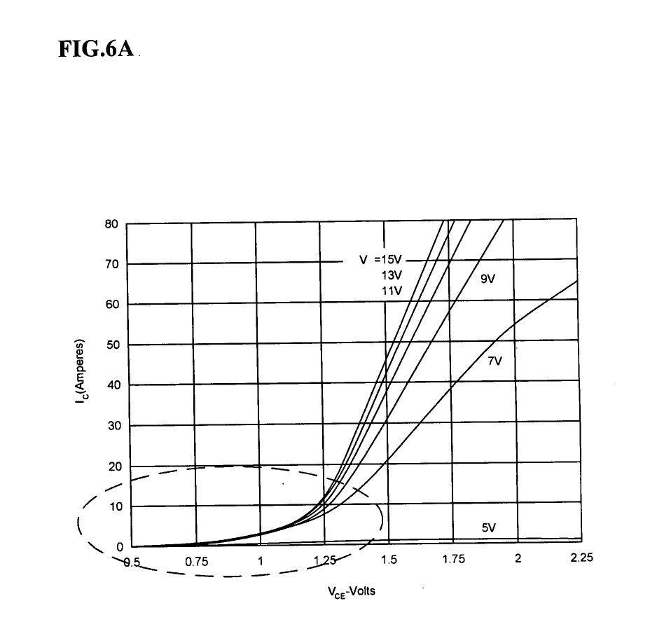

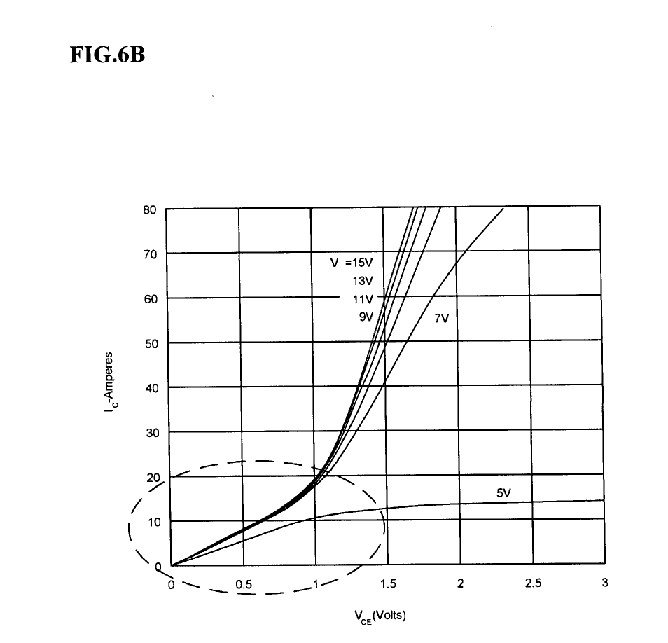

A drawback of the IGBT Q1 may arise from the voltage drop being greater when the IGBT Q1 is turned on or when the amount of current Ic of the IGBT Q1 is small, as compared to the MOSFET Q2. Hereinafter, the voltage drop in a switching element including only the IGBT Q1 when the switching element is turned on, and the voltage drop in the switching element 1000, which includes the IGBT Q1 and the MOSFET Q2 connected in parallel with each other as illustrated in FIG. 3, when the switching element 1000 is turned on, will be described with reference to FIGS. 6A and 6B.

FIG. 6A illustrates the relationship between a voltage Vce and a current Ic of the switching element including only the IGBT Q1, and FIG. 6B illustrates the voltage Vce and the current Ic of the switching element 1000.

Referring to regions surrounded by circles in FIG. 6A and FIG. 6B, i.e., regions where the amount of current Ic is small, when the switching element 1000 starts to be driven, the IGBT Q1 may be turned on later than the MOSFET Q2. The voltage drop in the switching element 1000 may therefore be smaller (switching at about 1 volt) than that in the switching element including only the IGBT Q1 (switching at about 1.25 volt). In a region outside the circle, i.e., in a region in which the amount of current Ic is large, even though the amount of current Ic increases, the voltage Vce of the switching element may be substantially uniform. From the above description, it may be seen that the efficiency of the switching element 1000 may be high even when a pulse discharge current flows, which may be generated when the plasma display apparatus is discharged.

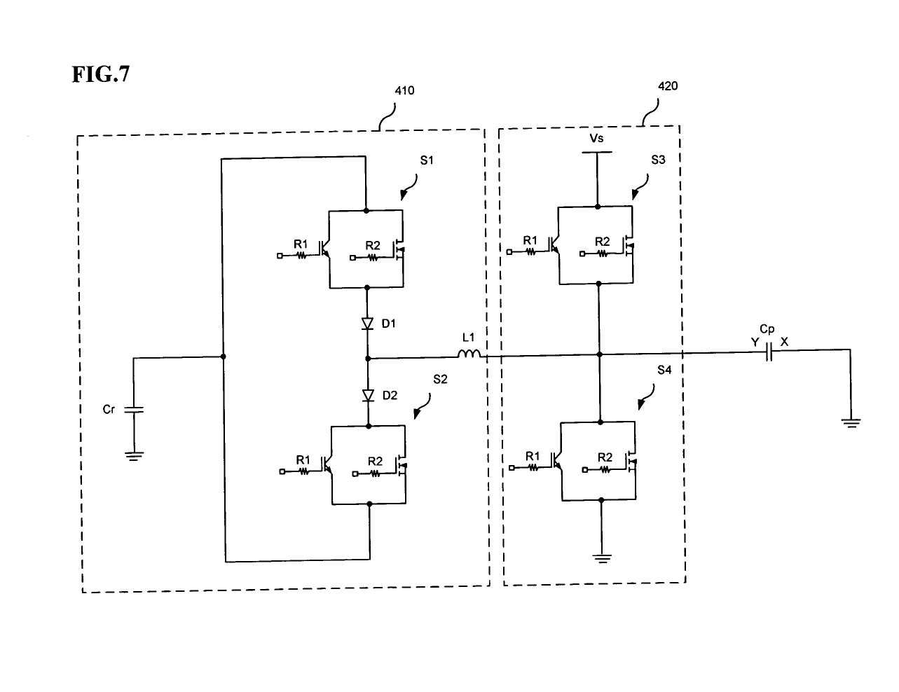

In general, when the plasma display apparatus is driven, during the sustain period of the driving waveform of the plasma display apparatus shown in FIG. 2, the switching element may be turned on/off most frequently to result in high power consumption. The driving of a sustain driver, which is included in the driving device of a plasma display apparatus using the switching element 1000, and which may alternately apply the voltage Vs and a voltage of about 0 V to the scan electrodes Y during the sustain period, will be described with reference to FIG. 7.

FIG. 7 illustrates a schematic diagram of a driving device for a plasma display apparatus, to which the switching element 1000 is applied.

As shown in FIG. 7, a driving device for a plasma display apparatus may include an energy recovery circuit (ERC) 410 and a sustain driver 420.

The ERC 410 may include a capacitor Cr having one end connected to a ground terminal, switching elements S1 and S2 connected to the other end of the capacitor Cr, a diode D1 having an anode connected to the switching element S1, a diode D2 having a cathode connected to the switching element S2 and an anode connected to a cathode of the diode D1, and an inductor L1 having one end connected to a connection point of the diodes D1 and D2 and the other end connected to the scan electrode Y. The capacitor Cr may be charged to about half the voltage Vs, i.e., a voltage of about Vs/2.

The sustain driver 420 may include switching elements S3 and S4 connected to the other end of the inductor L1. In the driving device, the switching elements S1, S2, S3, and S4 may be all composed of the switching elements 1000, as illustrated in FIG. 3.

The driving of the driving device for a plasma display apparatus according to the exemplary embodiment of the present invention shown in FIG. 7 will be briefly described below.

When the switching element S1 is turned on, the voltage of the scan electrode Y may increase to the voltage Vs due to resonance between the inductor L1 and a panel capacitor Cp, and when the switching element S3 is turned on, the voltage of the scan electrode Y may be held at the voltage Vs. Also, when the switching element S2 is turned on, the voltage of the scan electrode Y may decrease to about 0 V through resonance of the inductor L1 and the panel capacitor Cp. When the switching element S4 is turned on, the voltage of the scan electrode Y may be held at about 0 V. Here, the diodes D1 and D2 may block a reverse-direction current, which may be generated when the panel capacitor Cp is charged or discharged.

In the switching element, the resistor R1 connected to a control electrode of the IGBT Q1 may have a larger resistance than the resistor R2 connected to a control electrode of the MOSFET Q2. For this reason, when the switching element 1000 starts to be driven, the IGBT Q1 may be turned on later than the MOSFET Q2, which may make it possible to prevent a larger voltage drop from occurring when the amount of current flowing from the collector to the emitter of the IGBT Q1 at the time when the IGBT Q1 is turned on is small. Since the switching element 1000 is used, the efficiency of the driving device for a plasma display apparatus illustrated in FIG. 7 may be high even when the pulse discharge current, which may be generated when the plasma display apparatus is discharged, flows.

Meanwhile, the driving device illustrated in FIG. 7 may be included in a sustain electrode driver (reference numeral 500 in FIG. 1) for driving the sustain electrode X to supply the voltage Vs. The driving device according to the present invention may also be used as a driving device for applying the voltages VscH and VscL in the address period of the driving waveform of the plasma display apparatus illustrated in FIG. 2. For this, it may be necessary to apply the voltage VscH through the power supply terminal Vs connected to one end of the switching element S3, and to apply the voltage VscL through the ground terminal connected to one end of the switching element S4. Even during the address period, problems related to the heat generated from the switching element and voltage resistance of the switching element may easily occur. For this reason, the driving device using the switching element 1000 according to the exemplary embodiment of the present invention may be used.

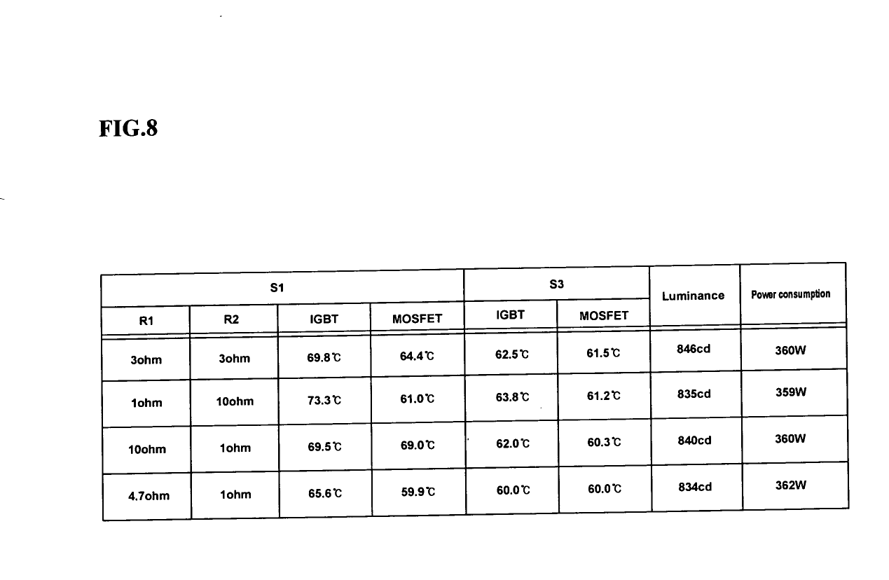

Hereinafter, referring to FIG. 8, variations in the temperatures of the switching elements S1 and S3 will be described. S1 and S3 may be turned on when the voltage Vs is applied, among the switching elements S1, S2, S3, and S4 included in the driving device for the plasma display apparatus illustrated in FIG. 7, according to the resistances of the resistors R1 and R2. The luminance and power consumption of the plasma display device correspond to the variation in the temperatures of the switching elements S1 and S2.

FIG. 8 illustrates a table representing the variation in the temperatures of the switching elements S1 and S3 according to the variation in the resistances of the resistors R1 and R2 included in the switching elements S1 and S3, and the luminance and power consumption of the plasma display apparatus corresponding to the variation in the temperatures of the switching elements S1 and S3. The table illustrated in FIG. 8 represents four representative experimental examples in which the resistances of the resistors R1 and R2 are varied.

In general, if the temperature of an element included in the driving device exceeds a predetermined level, the probability of the element being damaged or malfunctioning increases. Particularly, a switching element, such as the IGBT Q1 or the MOSFET Q2, may require large current capacity, and the temperature of the switching element may rise to about 70° C. or more due to heat generated by the switching element. In order to prevent adverse effects from occurring due to the above-mentioned characteristics of the switching element, multiple switching elements may be connected in parallel or in series. However, an increase in the number of elements may result in an increase in the cost of forming the plasma display apparatus. It may thus be necessary to have the temperature of the element when the element is driven be equal to or lower than a predetermined level without increasing the number of elements.

In addition, the driving characteristics of the switching element S1 may directly affect a sustain discharge pulse generated by the driving device of the plasma display apparatus illustrated in FIG. 7.

Further, a waveform of the sustain discharge pulse may affect driving characteristics of the switching element S3, luminance of an image displayed on the plasma display panel (100 of FIG. 1), and power consumption of the plasma display apparatus. Therefore, the resistances of the resistors R1 and R2 may be important factors that determine the driving characteristics of the switching element S1.

As described above with reference to FIGS. 4 to 7, when the switching element 1000 according to an embodiment of the present invention is turned on, the IGBT Q1 may be turned on later than the MOSFET Q2, which may improve the driving efficiency of the switching element. Referring to the table shown in FIG. 8, it may be seen that, when the resistor R1 connected to the control electrode of the IGBT Q1 has a resistance greatly different from the resistor R2 connected to the control electrode of the MOSFET Q2 by a predetermined level, an adverse effect of an excessive rise in the temperature of the MOSFET Q2 may occur. In contrast, when the resistances of the resistors R1 and R2 are respectively set to about 4.7 ohms and about 1 ohm, which may be optimum values obtained from the experimental results, the two switching element S1 and S3 both may operate at low temperature. In this experimental example, the luminance and power consumption of the plasma display apparatus may be observed to be similar to those in the other experimental examples. Therefore, when the switching element 1000 according to the exemplary embodiment of the present invention is used, it may be possible to obtain a driving device having high efficiency without appreciably lowering the luminance and/or without appreciably increasing the power consumption.

As described above, according to features of the invention, when the switching element including the IGBT Q1 and the MOSFET Q2 connected in parallel with each other is used, it may be possible to obtain a plasma display apparatus which is driven with a high efficiency not only when the switching element is turned on, but also when a pulse discharge current generated when the plasma display apparatus is discharged flows, without lowering the luminance of the plasma display apparatus or without increasing the power consumption of the plasma display apparatus.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display apparatus, comprising:
a plasma display panel that includes a plurality of first electrodes, a plurality of second electrodes, and a plurality of third electrodes formed to intersect the first and second electrodes;
first to third driving circuit units that drive the first to third electrodes; and
a controller that generates a control signal for controlling the driving of the first to third driving circuit units,
wherein the first driving circuit unit includes a first switching element having a first terminal connected to a first power source supplying a first voltage, the first switching element having a second terminal connected to the first electrodes,
the first switching element including at least one insulated gate bipolar transistor and at least one metal-oxide semiconductor field-effect transistor connected in parallel, and
a control electrode of the first switching element is connected to the first power source supplying the first voltage, the insulated gate bipolar transistor is turned on or off by a second voltage corresponding to the first voltage, and the metal-oxide semiconductor field-effect transistor is turned on or off by a third voltage corresponding to the first voltage, but is different from the second voltage.

2. The plasma display apparatus as claimed in claim 1, wherein:
the second driving circuit unit includes a second switching element having a first terminal connected to a second power source supplying a fourth voltage, the second switching element having a second terminal connected to the second electrodes,
the second switching element includes at least one insulated gate bipolar transistor and at least one metal-oxide semiconductor field-effect transistor that are connected in parallel, and
a control electrode of the second switching element is connected to the second power source supplying the fourth voltage, the insulated gate bipolar transistor is turned on or off by a fifth voltage corresponding to the fourth voltage, and the metal-oxide semiconductor field-effect transistor is turned on or off by a sixth voltage corresponding to the fourth voltage, but is different from the fifth voltage.

3. The plasma display apparatus as claimed in claim 2, wherein the first and fourth voltages are alternately applied during a sustain period.

4. The plasma display apparatus as claimed in claim 2, wherein:
the fifth voltage is a voltage to which the fourth voltage drops by a first resistor connected to a control electrode of the insulated gate bipolar transistor; and
the sixth voltage is a voltage to which the fourth voltage drops by a second resistor connected to a control electrode of the metal-oxide semiconductor field-effect transistor.

5. The plasma display apparatus as claimed in claim 4, wherein the first resistor has a resistance larger than the second resistor.

6. The plasma display apparatus as claimed in claim 4, wherein the first resistor has a resistance of about 4.7 ohm, and the second resistor has a resistance of about 1 ohm.

7. The plasma display apparatus as claimed in claim 1, wherein:
the third driving circuit unit includes a third switching element having a first terminal connected to a third power source supplying a seventh voltage and a second terminal connected to the third electrodes;
the third switching element includes at least one insulated gate bipolar transistor and at least one metal-oxide semiconductor field-effect transistor connected in parallel, and
a control electrode of the third switching elements is connected to the third power source supplying the seventh voltage, the insulated gate bipolar transistor is turned on or off by an eighth voltage corresponding to the seventh voltage, and the metal-oxide semiconductor field-effect transistor is turned on or off by a ninth voltage that corresponds to the seventh voltage but is different from the eighth voltage.

8. A driving device for a plasma display apparatus which includes a plurality of first electrodes, a plurality of second electrodes, and a plurality of the third electrodes formed to intersect the first and second electrodes, comprising:
a first switching element that has a first terminal connected to a first power source supplying a first voltage, the first switching element having a second terminal connected to the first electrodes,
wherein the first switching element includes at least one insulated gate bipolar transistor and at least one metal-oxide semiconductor field-effect transistor connected in parallel, and
a control electrode of the first switching element is connected to the first power source, the insulated gate bipolar transistor is turned on or off by a second voltage corresponding to the first voltage, and the metal-oxide semiconductor field-effect transistor is turned on or off by a third voltage corresponding to the first voltage, but is different from the second voltage.

9. The driving device as claimed in claim 8, further comprising a second switching element that has a first terminal connected to a second power source supplying a fourth voltage and a second terminal connected to the second electrodes,
wherein the second switching element includes at least one insulated gate bipolar transistor and at least one metal-oxide semiconductor field-effect transistor connected in parallel, and
a control electrode of the second switching element is connected to the second power source, the insulated gate bipolar transistor is turned on or off by a fifth voltage corresponding to the fourth voltage, and the metal-oxide semiconductor field-effect transistor is turned on or off by a sixth voltage corresponding to the fourth voltage, but is different from the fifth voltage.

10. The driving device as claimed in claim 8, further comprising:
a third power source that supplies a seventh voltage; and
a third switching element that has a first terminal connected to a third power source supplying a seventh voltage and a second terminal connected to the third electrodes,
wherein the third switching element includes at least one insulated gate bipolar transistor and at least one metal-oxide semiconductor field-effect transistor connected in parallel, and
the control electrodes of the first and second switching elements are connected to the third power source, the insulated gate bipolar transistor is turned on or off by an eighth voltage corresponding to the seventh voltage, and the metal-oxide semiconductor field-effect transistor is turned on or off by a ninth voltage corresponding to the seventh voltage, but is different from the eighth voltage.

11. The plasma display apparatus as claimed in claim 10, wherein the seventh voltage is an address data voltage sequentially applied to the plurality of third electrodes in an address period.

12. The plasma display apparatus as claimed in claim 10, wherein the eighth voltage is lower than the ninth voltage.

13. The plasma display apparatus as claimed in claim 10, wherein:
the eighth voltage is a voltage to which the seventh voltage drops by a first resistor connected to a control electrode of the insulated gate bipolar transistor, and
the ninth voltage is a voltage to which the seventh voltage drops by a second resistor connected to a control electrode of the metal-oxide semiconductor field-effect transistor.

14. The plasma display apparatus as claimed in claim 13, wherein the first resistor has a larger resistance than the second resistor.

15. A switching element for a plasma display apparatus, comprising:
at least one insulated gate bipolar transistor that is turned on or off by a second voltage corresponding to a first voltage; and
at least one metal-oxide semiconductor field-effect transistor that is connected in parallel with the insulated gate bipolar transistor and is turned on or off by a third voltage corresponding to the first voltage, but is different from the second voltage.

16. The switching element as claimed in claim 15, wherein the second voltage is lower than the third voltage.

17. The switching element as claimed in claim 15, wherein:
the second voltage is a voltage to which the first voltage drops by a first resistor connected to a control electrode of the insulated gate bipolar transistor, and
the third voltage is a voltage to which the first voltage drops by a second resistor connected to a control electrode by the metal-oxide semiconductor field-effect transistor.

18. The switching element as claimed in claim 17, wherein the first resistor has a resistance higher than the second resistor.

19. The switching element as claimed in claim 15, wherein the plasma display apparatus includes a plurality of first electrodes, a plurality of second electrodes, and a plurality of the third electrodes formed to intersect the first and second electrodes, and the switching element supplies a fourth voltage and a fifth voltage higher than the fourth voltage alternately applied to the first electrodes during a sustain period.

20. The switching element as claimed in claim 19, wherein the switching element supplies an address data voltage that is sequentially applied to the plurality of third electrodes during an address period.
